(19) United States
(12) Patent Application Publication
(10) Pub. No.: US 2008/0055564 A1
(43) Pub. Date: Mar. 6, 2008

(54) INTERACTIVE DOCUMENT CAMERA AND SYSTEM OF THE SAME

(75) Inventors: Yung-Che Chang, Taipei (TW); Jye-Ching Cheng, Taipei (TW); I-Chang Yang, Taipei (TW); Christopher Yen, Taipei (TW)

Correspondence Address: KIRTON AND MCCONKIE, 60 EAST SOUTH TEMPLE,, SUITE 1800, SALT LAKE CITY, UT, 84111, US

(73) Assignee: AVERMEDIA TECHNOLOGIES, INC., Taipei Hsien (TW)

(21) Appl. No.: 11/672,605

(22) Filed: Feb. 8, 2007

(30) Foreign Application Priority Data
Aug. 30, 2006 (TW) 095132069

(51) Int. Cl. G03B 21/22

(52) U.S. Cl. 353/71

(57) ABSTRACT

An interactive document camera system includes a document camera, a display panel, and a handwriting sensor module. The document camera can simultaneously output an image of an object and a handwriting input obtained from the handwriting sensor module. The inactive document camera system further includes a computer system so that an operating image provided by the computer system can be simultaneously outputted, and a handwriting data corresponding to the handwriting input can be recorded in the computer system. The interactive document camera includes an image-sensing and processing unit, different connecting interfaces and an image synthesizer. The different connecting interfaces are selectively connected to and communicated with a display panel, a handwriting sensor module or a computer system.

### FIELD OF THE INVENTION

The present invention relates to an interactive document camera and an interactive document camera system for projecting an image of an object, and more particularly to an interactive document camera and an interactive document camera system using a handwriting sensor module to show annotations on the projected image.

### BACKGROUND OF THE INVENTION

A document camera or a digital visual presenter is a special camera designed to give a presentation, hold a meeting or give a lecture in classroom, boardroom, or conference. By using the document camera, the lecturer may directly display images of a writing or graphic object to assisting understanding.

Generally, the document cameras or the digital visual presenters have many useful features as video cameras or scanners have, for example image capturing, image scanning and image outputting functions. Like digital video cameras, digital still cameras, surveillance cameras or PC cameras, the camera modules used in the document cameras for sensing images are usually CMOS (complementary metal-oxide semiconductor) image sensing modules or CCD (charged coupled device) image sensing modules. The document camera or the digital visual presenter may be communicated with a projector. The captured images to be shown to the audience will be projected onto a screen through the projector. Moreover, the camera module contained in the document camera or the digital visual presenter may transmit the captured images to a television or a computer monitor so as to display live video images. In addition, the objects to be shown through the document camera or the digital visual presenter may be planar or three dimensional objects.

Conventionally, it is inconvenient for giving a presentation because the speech manuscripts, reference documents or drawings should have been previously scanned by an image scanner, transformed into image files and then displayed on a computer monitor or a projector screen. In addition, the documents or drawings may have been previously printed on the transparent slides by colorful or black-and-white printing. The use of the document camera or the digital visual presenter may significantly reduce the burden of preparing presentation and easily allow the lecturer to share details with the audience.

The document cameras are principally classified into two types; one is portable document camera and the other is flatbed document camera. The functions, the applications and the costs of these two document cameras are somewhat distinguished. Generally, the portable document camera can be carried to other locations as needed because it is relatively lighter and handier. Due to the portability, the portable document camera 10 lacks the platform or other platforms with expanded functionality. In comparison with the flatbed document camera, the portable document camera has limited functions.

Referring to FIG. 1, a schematic diagram of a conventional flatbed document camera 10 used for projecting images of an object 1 in a presentation is illustrated. The flatbed document camera 10 has a camera module 11 such as a CCD or CMOS image sensing module. In addition, the flatbed document camera 10 has a platform 101 for placing the object 1 thereon. Optionally, a light box 102 is disposed within the platform 101 for emitting a light on the object 1. In addition, the flatbed document camera 10 has a lighting module 111 for providing light compensation such that the images of the object 1 will be clearly captured by the camera module 11. During operation, the object 1 is placed under the camera module 11 such that the images of the object 1 are captured by the camera module 11 and transmitted to a projector 12. Then, the captured images are projected onto a screen 14 through the projector 12, so that the images of the object 1 will be displayed on the screen 14.

For giving a presentation, the speaker usually stands at the location in front of the audience and face to the audience. That is, the projection screen is in back of the speaker. For viewing the projected images, the speaker needs to turn his head frequently. Under this circumstance, the speaker fails to make up smooth speech. For improving the performance, a document camera with a small monitor (e.g. a LCD panel) was developed. The small monitor may allow the speaker to see the images to be projected on the screen 14 without turning around to see the projection screen 14, thereby facilitating the speech.

Typically, this small monitor is directly arranged on the platform of the flatbed document camera or externally wired to the document camera in order to display the images of the object in real-time. Referring to FIG. 2(a), a schematic diagram of a document camera 20 with a small monitor 22 is illustrated. In comparison with FIG. 1, this document camera 20 has an additional small monitor 22 arranged on the platform 201. Since the small monitor 22 is electrically connected to the camera module 21, the images of the object 2 captured by the camera module 21 can be displayed on the small monitor 22 and/or the projection screen simultaneously.

Moreover, the small monitor 22 is substantially a touch panel. By touching a specified location on the touch panel, a control signal is generated to have related controllers or processors execute a selected function. In FIG. 2(b), an annotation menu 221 and a control panel 222 are also displayed on the small monitor 22. By touching the virtual function keys of the annotation menu 221 or the control panel 222, the functions corresponding to the selected virtual function keys are actuated. Examples of the functions include zoom in/zoom out, brightness or level adjustment of the images and so on.

As previously described, the small monitor may allow the speaker to preview the projected images and the virtual function keys thereon may be triggered to execute selected functions. However, the document camera with a small monitor still has some drawbacks. For example, it is not cost-effective. In addition, the small monitor is principally used for previewing the projected images while the other functions of the small monitor may be implemented by the general flatbed document camera. As a consequence, is seems that the small monitor has limited contribution to the document camera and it is difficult to become popular due to the cost consideration.

Therefore, there is a need of expanding the functions of the small monitor used in the document camera.

### SUMMARY OF THE INVENTION

The present invention provide an interactive document camera and an interactive document camera system for projecting an image of an object, in which a handwriting sensor module is used to make a handwriting annotation on the projected image and the image data with the annotation may be recorded into the computer system.

In accordance with an aspect of the present invention, there is provided an interactive document camera system. The interactive document camera system comprises a document camera, a display panel and a handwriting sensor module. The document camera is used for capturing and outputting an image of an object to be displayed. The display panel is electrically connected to the document camera for displaying the image of the object outputted from the document camera. The handwriting sensor module is electrically connected to the document camera for a handwriting input, so that a handwriting data corresponding to the handwriting input and the image of the object are simultaneously outputted by the document camera.

In an embodiment, the document camera further includes a first connecting interface, and the display panel is electrically connected to the document camera through the first connecting interface.

In an embodiment, the handwriting sensor module includes a handwriting board for the handwriting input.

In an embodiment, the handwriting board includes a multifunction menu having several virtual function keys. By touching one of the virtual function keys, the corresponding function is actuated.

In an embodiment, the handwriting sensor module further includes a touch pen for making the handwriting input on the handwriting board in a touching and pressing manner.

In an embodiment, the document camera further includes a second connecting interface, and the handwriting board is electrically connected to the document camera through the second connecting interface.

In an embodiment, the handwriting board is arranged on the display panel and made transparent such that the image shown on the display panel is visible through the handwriting board.

In an embodiment, the area of the handwriting board is substantially equal to that of the display panel.

In accordance with another aspect of the present invention, there is provided an interactive document camera for capturing and outputting an image of an object and used with a display panel. The display panel has a handwriting input function. The interactive document camera comprises an image-sensing and processing unit, a first connecting interface and an image synthesizer. The image-sensing and processing unit is used for capturing and processing the image of the object and outputting the processed image. The first connecting interface is electrically connected to the image-sensing and processing unit and the display panel. The first connecting interface outputs the image of the object to the display panel. The first connecting interface also outputs a handwriting data in response to a handwriting input. The image synthesizer is electrically connected to the image-sensing and processing unit and the first connecting interface for synthesizing the image of the object and the handwriting data and outputting the synthesized images.

In accordance with another aspect of the present invention, there is provided an interactive document camera for capturing and outputting an image of an object and used with a handwriting sensor module and a display panel. The interactive document camera includes an image-sensing and processing unit, a first connecting interface, a second connecting interface, and an image synthesizer. The image-sensing and processing unit is used for capturing and processing the image of the object and outputting the processed image. The first connecting interface is electrically connected to the image-sensing and processing unit, so that the image of the object is simultaneously shown on the display panel. The second connecting interface is electrically connected to the handwriting sensor module to output a handwriting data received from the handwriting sensor module. The image synthesizer is electrically connected to the image-sensing and processing unit and the second connecting interface for synthesizing the image of the object and the handwriting data to output synthesized images.

In accordance with another aspect of the present invention, there is provided an interactive document camera system comprising a document camera, a display panel, a handwriting sensor module and a computer system. The document camera is used for capturing and outputting an image of an object to be displayed. The display panel is electrically connected to the document camera for displaying the image of the object outputted from the document camera. The handwriting sensor module is electrically connected to the document camera for a handwriting input, so that the handwriting data corresponding to the handwriting input and the image of the object are simultaneously outputted from the document camera. The computer system is electrically connected to the document camera, so that the operating image provided by the computer system is simultaneously outputted by the document camera and the handwriting data is recorded into the computer system.

In an embodiment, the document camera further includes a first connecting interface, and the display panel is electrically connected to the document camera through the first connecting interface.

In an embodiment, document camera further includes a second connecting interface so that the computer system may be electrically connected to the document camera through the second connecting interface.

In accordance with another aspect of the present invention, there is provided an interactive document camera for capturing and outputting an image of an object and used with a display panel having a handwriting input function and a computer system. The interactive document camera includes an image-sensing and processing unit, a first connecting interface, a second connecting interface, and an image synthesizer. The image-sensing and processing unit is used for capturing and processing the image of the object and outputting the processed image. The first connecting interface is electrically connected to the image-sensing and processing unit and the display panel, so that the image of the object is simultaneously shown on the display panel and handwriting data corresponding to the handwriting input are also outputted. The second connecting interface is electrically connected to the image-sensing and processing unit and the computer system, so that the image provided by the computer system is simultaneously outputted from the document camera and the handwriting data is recorded into the computer system. The image synthesizer is electrically connected to the image-sensing and processing unit, the first connecting interface and the second connecting interface for synthesizing the image of the object, the handwriting data and the operating image to output synthesized images.

In accordance with another aspect of the present invention, there is provided an interactive document camera for capturing and outputting an image of an object. The interactive document camera comprises a main body, an image-sensing and processing unit and an interactive platform. The image-sensing and processing unit is disposed on the main body for capturing and processing the image of the object and outputting the processed image. The interactive platform is disposed on the main body for placing the object and receiving a handwriting input. The interactive platform can senses the handwriting input so that the handwriting input is processed and outputted by the image-sensing and processing unit.

In an embodiment, the interactive platform is electrically connected to the image-sensing and processing unit and includes a multifunction menu having several virtual function keys. By touching one of the virtual function keys, the corresponding function is actuated.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic diagram of a conventional flatbed document camera used for projecting images of an object;

FIG. 2(a) is a schematic diagram of a document camera with a small monitor;

FIG. 2(b) is a schematic diagram showing the small monitor of FIG. 2(a);

FIG. 3(a) is a schematic perspective view of an interactive document camera system according to a first preferred embodiment of the present invention;

FIG. 3(b) is a schematic circuit block diagram of the interactive document camera system of FIG. 3(a);

FIG. 3(c) is a schematic diagram showing another assembly manner of the platform and the display panel;

FIG. 4(a) is a schematic perspective view of an interactive document camera system according to a second preferred embodiment of the present invention;

FIG. 4(b) is a schematic circuit block diagram of the interactive document camera system of FIG. 4(a);

FIG. 5(a) is a schematic perspective view of an interactive document camera system according to a third preferred embodiment of the present invention;

FIG. 5(b) is a schematic circuit block diagram of the interactive document camera system of FIG. 5(a); and

FIG. 6 is a schematic perspective view of an interactive document camera according to a fourth preferred embodiment of the present invention.

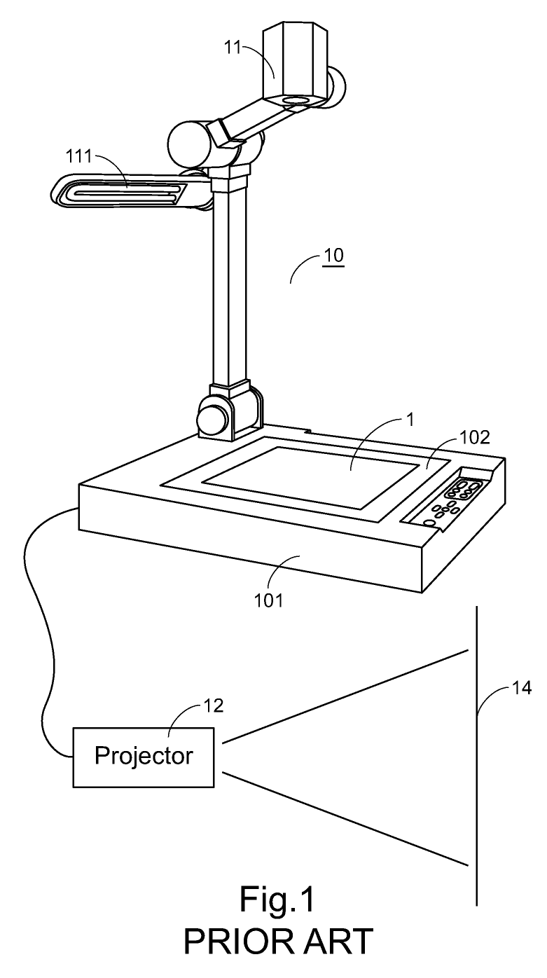

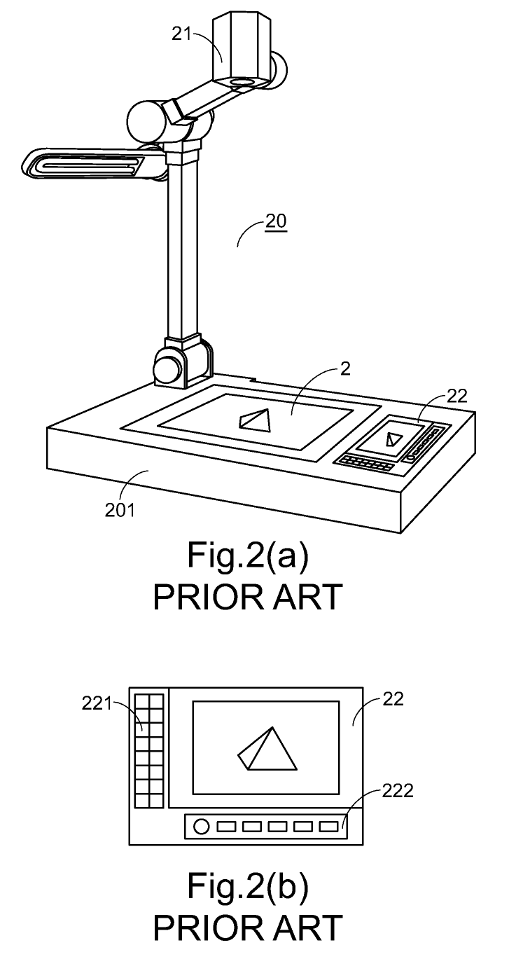

### DETAILED DESCRIPTION OF THE PREFERRED EMBODIMENT

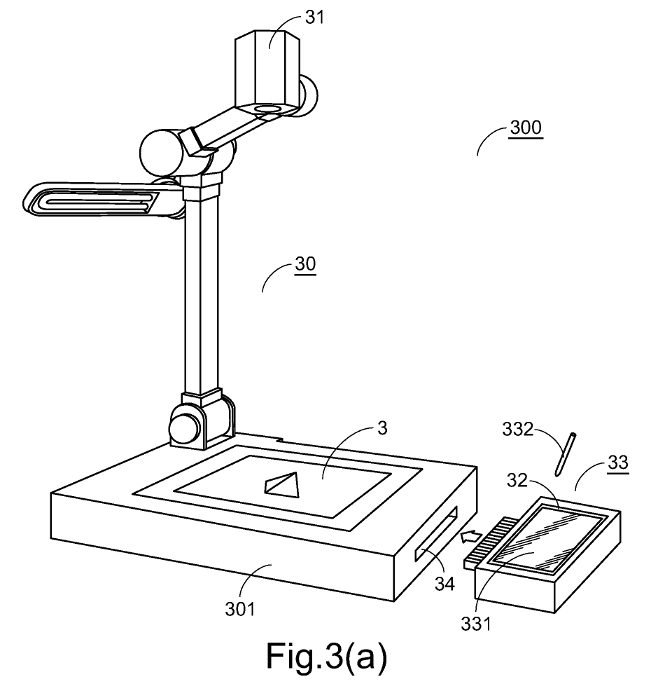

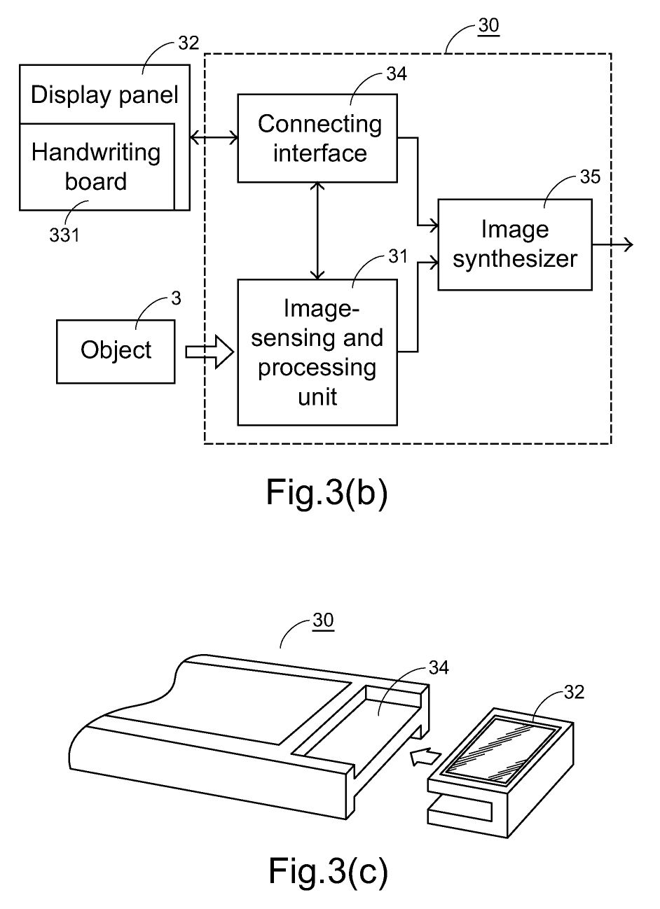

Referring to FIG. 3(a), a schematic perspective view of an interactive document camera system 300 according to a first preferred embodiment of the present invention is illustrated. The interactive document camera system 300 comprises a document camera 30, a display panel 32 and a handwriting sensor module 33. The handwriting sensor module 33 includes a handwriting board 331. The document camera 30 includes a platform 301 and an image-sensing and processing unit 31. An object 3 to be displayed is placed on the platform 301. The images of the object 3 are captured and processed by the image-sensing and processing unit 31. The document camera 30 further includes a connecting interface 34. After the display panel 32 is coupled with the connecting interface 34, the display panel 32 is electrically connected to the document camera 30. The handwriting board 331 is an interactive touch pad allowing handwriting input. In this embodiment, the handwriting board 331 is arranged on the display panel 32. Since the handwriting board 331 is made transparent, the speaker may write notes or make marks on the handwriting board 331 while viewing the images shown on the display panel 32.

Hereinafter, an operating embodiment of the interactive document camera system 300 will be illustrated with reference to FIG. 3(b). FIG. 3(b) is a schematic circuit block diagram of the interactive document camera system 300. The images of the object 3 are captured and processed by the image-sensing and processing unit 31, and then the processed images are outputted. The connecting interface 34 is electrically connected to the image-sensing and processing unit 31. After the display panel 32 is coupled with the connecting interface 34, the display panel 32 is electrically connected with the connecting interface 34 such that the images of the object 3 captured by the image-sensing and processing unit 31 may be displayed on the display panel 32. Under this circumstance, like the small monitor as described above, the display panel 32 allows the speaker to see the projected images without turning to look at the projection screen. Moreover, since the function of the handwriting board 331 is integrated into the display panel 32, the user may use a touch pen 332 as shown in FIG. 3(a) (which is an accessory of the handwriting sensor module 33) to write notes on the handwriting board 331 in a touching and pressing manner. The handwriting input may be sensed and displayed on the handwriting board 331. In addition, via the connecting interface 34, the handwriting data corresponding to the handwriting input can be outputted.

The document camera 30 further includes an image synthesizer 35. The image synthesizer 35 is electrically connected to the image-sensing and processing unit 31 and the connecting interface 34. By means of the image synthesizer 35, the images of the object 3 and the handwriting data outputted by the handwriting board 331 are synthesized and then outputted. Please refer to FIG. 3(a) again. The handwriting board 331 is made transparent and arranged on the display panel 32. Especially, the area of the handwriting board 331 is substantially equal to that of the display panel 32. As a consequence, the speaker may write notes on the handwriting board 331 while viewing the images shown on the display panel 32. For example, the speaker may directly add annotations on the projected image via the handwriting board 331. Since the images of the object 3 and the handwriting data are superimposed by the image synthesizer 35, the images of the object 3 and the handwriting data are simultaneously outputted. Therefore, as making notes on the white board, the interactive document camera system 300 can be used for interactive demonstrations while displaying the images in real-time.

Moreover, the handwriting board 331 further includes a multifunction menu, which includes several virtual function keys. By touching the virtual function keys of the multifunction menu, the functions corresponding to the selected virtual function keys are actuated. Examples of the functions include zoom in/zoom out, brightness or level adjustment of the images and so on. Since the handwriting board 331 is arranged on the display panel 32, the handwriting board 331 may be designed to be electrically connected to the image-sensing and processing unit 31 when the display panel 32 is coupled with the connecting interface 34. Under this circumstance, by touching the virtual function keys on the multifunction menu, the functions corresponding to the selected virtual function keys are actuated to have the image-sensing and processing unit 31 respond to the request. The processed images may be transmitted to a projector and projected onto a projection screen for the audience. The operation principles of projector and the projection screen are known in the art and are not redundantly described herein.

It is noted that, however, those skilled in the art will readily observe that numerous modifications and alterations of the connection between the display panel 32 and the document camera 30 may be made while retaining the teachings of the invention. Since the display panel 32 is an external function expansion device of the document camera 30, the connecting interface 34 and the display panel 32 should have complementary shapes in order to be coupled with each other. For example, as shown in FIG. 3(a), the connecting interface 34 is a slot, and the display panel 32 has a protruding connecting portion to be inserted into the connecting interface 34. Alternatively, the display panel 32 has a recess structure and the connecting interface 34 is substantially a connecting plate to be inserted into the recess structure. The complementary shapes of the connecting interface 34 and the display panel 32 are not restricted as long as they are coupled with and electrically connected to each other.

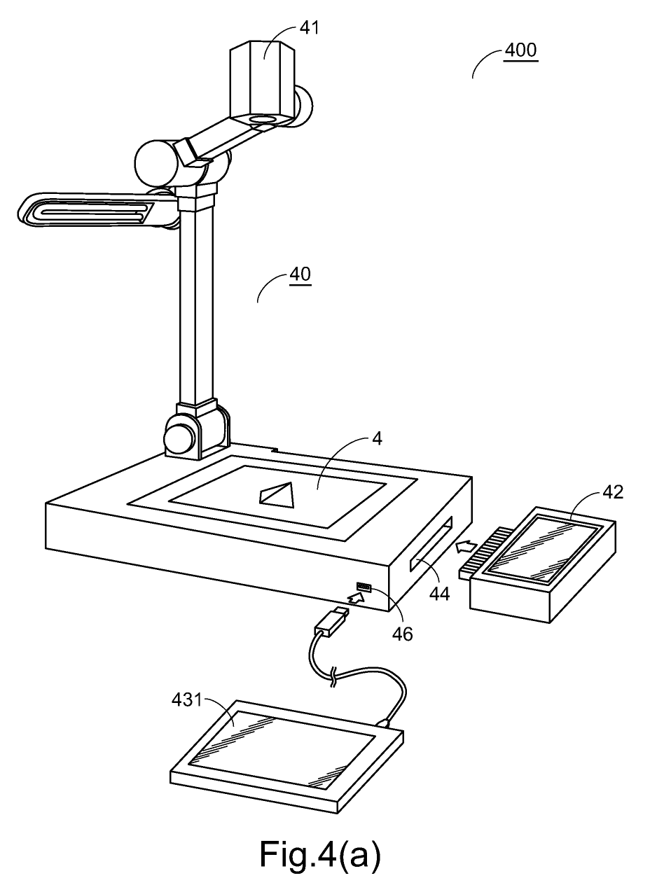

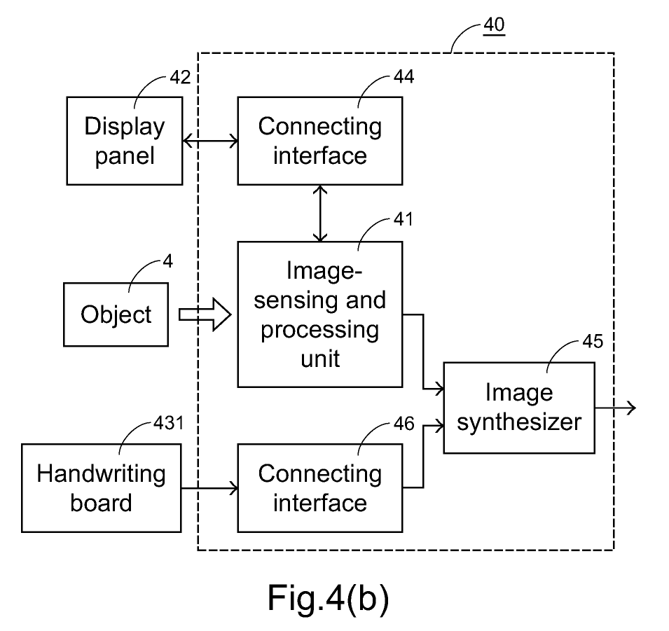

In the first embodiment, the handwriting board 331 is integrated into the display panel 32. Alternatively, the handwriting board 331 and the display panel 32 may be separate components. Referring to FIG. 4(a), a schematic perspective view of an interactive document camera system 400 according to a second preferred embodiment of the present invention is illustrated. For clarification and comparison, the elements corresponding to those in FIG. 3(a) will be designated by similar numeral references. As shown in FIG. 4(a), the interactive document camera system 400 includes a first connecting interface 44 and a second connecting interface 46. After the display panel 42 is coupled with the connecting interface 44, the display panel 42 is electrically connected to the document camera 40. Similarly, the handwriting board 431 is electrically connected to the document camera 40 when the handwriting board 431 is coupled to the second connecting interface 46.

Please refer to FIG. 4(a) again. The second connecting interface 46 is a USB port and the handwriting board 431 is coupled with the second connecting interface 46 via a USB transmission interface. Since most commercially available handwriting boards have USB transmission interfaces, the document camera 40 is designed to be compatible with these commercially available handwriting boards. Due to the cost consideration, the user may purchase the document camera 40 in advance. For allowing the speaker to see the projected images in a more convenient manner, the display panel 42 may be added to the interactive document camera system 400. For allowing interactive demonstrations, the handwriting board 431 may be further added to the interactive document camera system 400 and the images are projected with the handwriting annotations.

FIG. 4(b) is a schematic circuit block diagram of the interactive document camera system 400. In comparison of FIG. 3(b), the document camera 40 further includes an additional connecting interface 46 and the handwriting board 431 is separated from the display panel 42. After the handwriting board 431 is coupled with the second connecting interface 46, the handwriting board 431 is electrically connected to the document camera 40 so that the handwriting data corresponding to the handwriting input can be outputted. Moreover, the image synthesizer 45 of the document camera 40 is electrically connected to the image-sensing and processing unit 41 and the second connecting interface 46. By means of the image synthesizer 45, the images of the object 4 and the handwriting data outputted by the handwriting board 431 are synthesized and then outputted. Since the handwriting board 431 is separated from the display panel 42, the images of the object 4 are not shown on the handwriting board 431. Under this circumstance, if the speaker wants to see the synthesized image, has to turn and see the projection screen.

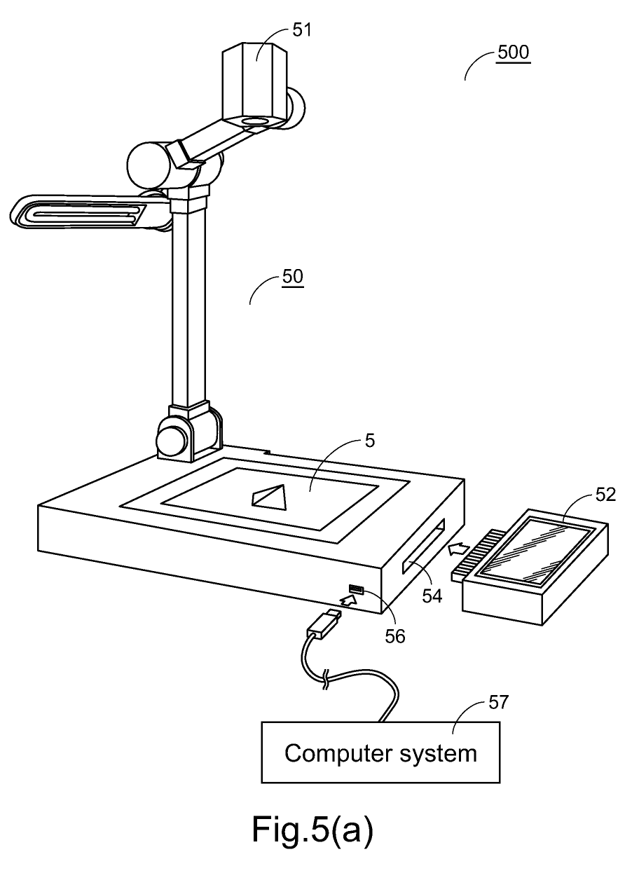

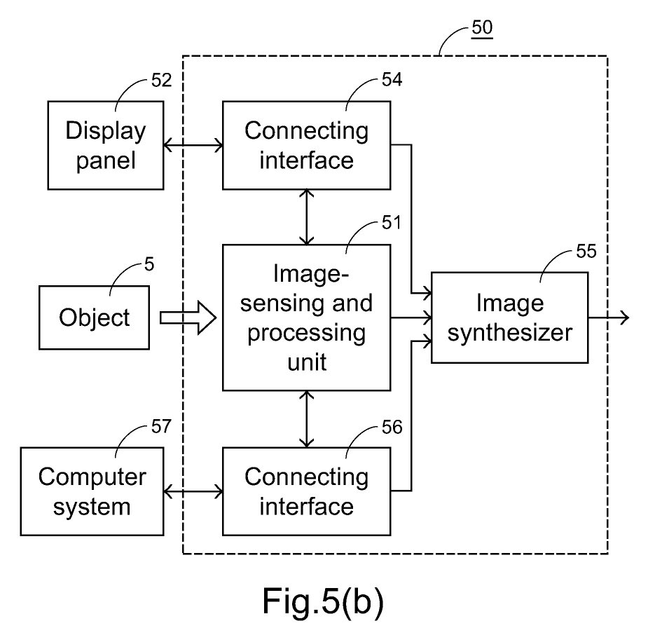

Referring to FIG. 5(a), a schematic perspective view of an interactive document camera system 500 according to a third preferred embodiment of the present invention is illustrated. In comparison of FIG. 3(a), the document camera 50 further includes an additional connecting interface 56 and is capable of supporting a computer system 57. In this embodiment, the handwriting board is integrated into the display panel 52. The document camera 50 may be electrically connected to the computer system 57 and the display panel 52 including the handwriting board. As shown in FIG. 5(a), the interactive document camera system 500 includes a first connecting interface 54 and a second connecting interface 56. After the display panel 52 is coupled with the first connecting interface 54, the display panel 52 is electrically connected to the document camera 50. Similarly, the computer system 57 is electrically connected to the document camera 50 when the computer system 57 is coupled with the second connecting interface 56.

FIG. 5(b) is a schematic circuit block diagram of the interactive document camera system 500. In comparison of FIG. 3(b), the document camera 50 further includes the second connecting interface 56. The second connecting interface 56 is electrically connected to the image-sensing and processing unit 51. After the computer system 57 is coupled with the second connecting interface 56, the computer system 57 is electrically connected with the document camera 50 such that the operating images provided by the computer system 57 may be processed by the image-sensing and processing unit 51 and then outputted. Moreover, in this embodiment, the second connecting interface 56 is electrically connected to the image-sensing and processing unit 51. As a consequence, the handwriting data corresponding to the handwriting input is processed by the image-sensing and processing unit 51 and then stored in the computer system 57. Moreover, the image synthesizer 55 of the document camera 50 is electrically connected to the image-sensing and processing unit 51, the first connecting interface 54 and the second connecting interface 56. By means of the image synthesizer 55, the images of the object 5, the annotations and the operating images are synthesized and then outputted.

In this embodiment, the operating images provided by the computer system 57 may be displayed on the projection screen as a background. The images of the object 5 or the handwriting data are also displayed on the screen so as to be displayed with the operating images provided by the computer system 57. For example, a graphic or text file of the computer system 57 may be opened in order to provide further demonstrations. Under this circumstance, the document camera 50 of the interactive document camera system 500 is served as an intermediate control medium between the display panel 52 and the computer system 57. By means of related software and hardware such as the multifunction menu, the display panel 52 and the computer system 57 can interact with each other. In an interactive example, the handwriting data corresponding to the handwriting input are recorded in the computer system 57 and saved as graphic files. As a result, the image data can be effectively stored.

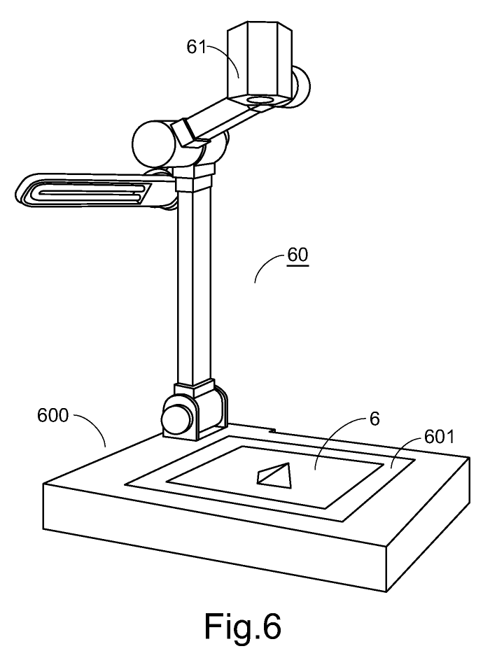

Referring to FIG. 6, a schematic perspective view of an interactive document camera 60 according to a fourth preferred embodiment of the present invention is illustrated. The interactive document camera 60 includes a main body 600, an image-sensing and processing unit 61 and an interactive platform 601. The image-sensing and processing unit 61 is disposed on the main body 600. In this embodiment, an object 6 to be displayed is placed on the interactive platform 601 and the images of the object 6 are captured by the image-sensing and processing unit 61. More especially, the function of the handwriting board is integrated into the interactive platform 601. The images of the object 6 are captured and processed by the image-sensing and processing unit 61. The user may use a touch pen to write notes on the interactive platform 601. The handwriting input may be sensed and displayed on the interactive platform 601. The handwriting input may also be captured and processed by the image-sensing and processing unit 61, and the handwriting data corresponding to the handwriting input are then outputted.

In a case that no object is placed on the interactive platform 601, the interactive platform 601 is served as a handwriting board. In other embodiments, the interactive platform 601 is electrically connected to the image-sensing and processing unit 61. Under this circumstance, a multifunction menu including several virtual function keys is shown on the interactive platform 601. By touching the virtual function keys, the functions corresponding to the selected virtual function keys are actuated by the image-sensing and processing unit 61.

As previously described, the document camera with a small monitor is disadvantageous because the small monitor is not cost-effective and has limited contribution. By using the interactive document camera system of the present invention, desired external function expansion devices are selectively attached onto the document camera according the users' requirement. Due to the external function expansion devices, the functions of the document camera are expanded to enhance the presentation performance. As a result, the general flatbed document camera is improved by introducing the interactive property.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An interactive document camera system comprising:
a document camera for capturing and outputting an image of an object to be displayed;
a display panel electrically connected to said document camera for displaying the image of the object outputted from said document camera; and
a handwriting sensor module electrically connected to said document camera for a handwriting input, so that a handwriting data corresponding to the handwriting input and the image of the object are simultaneously outputted by said document camera.

2. The interactive document camera system according to claim 1 wherein said document camera further comprises a first connecting interface, and said display panel is electrically connected to said document camera through said first connecting interface.

3. The interactive document camera system according to claim 1 wherein said handwriting sensor module comprises a handwriting board for the handwriting input.

4. The interactive document camera system according to claim 3 wherein said handwriting board comprising a multifunction menu having a plurality of virtual function keys, wherein touching one of said virtual function keys of said multifunction menu actuates function corresponding to said one virtual function key.

5. The interactive document camera system according to claim 3 wherein said handwriting sensor module further comprises a touch pen for making the handwriting input on said handwriting board in a touching and pressing manner.

6. The interactive document camera system according to claim 3 wherein said document camera further comprises a second connecting interface, and said handwriting board is electrically connected to said document camera through said second connecting interface.

7. The interactive document camera system according to claim 3 wherein said handwriting board is arranged on said display panel and made transparent such that the image shown on said display panel is visible through said handwriting board.

8. The interactive document camera system according to claim 7 wherein the area of said handwriting board is substantially equal to that of said display panel.

9. An interactive document camera for capturing and outputting an image of an object and used with a display panel having a handwriting input function, said interactive document camera comprising:
an image-sensing and processing unit for capturing and processing the image of the object and outputting the processed image;
a first connecting interface electrically connected to said image-sensing and processing unit and the display panel for outputting the image of the object to the display panel and outputting a handwriting data in response to a handwriting input; and
an image synthesizer electrically connected to said image-sensing and processing unit and said first connecting interface for synthesizing the image of the object and the handwriting data and outputting a synthesized image.

10. An interactive document camera for capturing and outputting an image of an object and used with a handwriting sensor module and a display panel, comprising:
an image-sensing and processing unit for capturing and processing the image of the object and outputting the processed image;
a first connecting interface electrically connected to the image-sensing and processing unit, wherein the image of the object is simultaneously shown on the display panel when the display panel is coupled to said interactive document camera through said first connecting interface;
a second connecting interface to be electrically connected to the handwriting sensor module for outputting a handwriting data received from the handwriting sensor module; and
an image synthesizer electrically connected to said image-sensing and processing unit and said second connecting interface for synthesizing the image of the object and the handwriting data and outputting a synthesized image.

11. An interactive document camera system comprising:
a document camera for capturing and outputting an image of an object to be displayed;
a display panel electrically connected to said document camera for displaying the image of the object outputted from said document camera;
a handwriting sensor module electrically connected to said document camera for a handwriting input, so that a handwriting data corresponding to the handwriting input and the image of the object are simultaneously outputted by said document camera; and
a computer system electrically connected to said document camera, so that an operating image provided by said computer system is simultaneously outputted by said document camera and the handwriting data is recorded into said computer system.

12. The interactive document camera system according to claim 11 wherein said document camera further comprises a first connecting interface, and said display panel is electrically connected to said document camera through said first connecting interface.

13. The interactive document camera system according to claim 11 wherein said handwriting sensor module comprises a handwriting board for the handwriting input.

14. The interactive document camera system according to claim 13 wherein said handwriting sensor module further comprises a touch pen for making the handwriting input on said handwriting board in a touching and pressing manner.

15. The interactive document camera system according to claim 13 wherein said handwriting board is arranged on said display panel and made transparent such that the image shown on said display panel is visible through said handwriting board.

16. The interactive document camera system according to claim 13 wherein said document camera further includes a second connecting interface, and said computer system is electrically connected to said document camera through said second connecting interface.

17. An interactive document camera for capturing and outputting an image of an object and used with a display panel having a handwriting input function and a computer system, said interactive document camera comprising:
an image-sensing and processing unit for capturing and processing the image of the object and outputting the processed image;
a first connecting interface electrically connected to the image-sensing and processing unit and the display panel for outputting the image of the object to the display panel and outputting a handwriting data in response to a handwriting input;
a second connecting interface electrically connected to said image-sensing and processing unit and the computer system, so that an operating image provided by the computer system is simultaneously outputted from said document camera and the handwriting data is recorded into the computer system; and
an image synthesizer electrically connected to said image-sensing and processing unit, said first connecting interface and said second connecting interface for synthesizing the image of the object, the handwriting data and the operating image and outputting a synthesized image.

18. An interactive document camera for capturing and outputting an image of an object, comprising:
a main body;
an image-sensing and processing unit disposed on said main body for capturing and processing the image of the object and outputting the processed image; and
an interactive platform disposed on said main body for placing thereon the object and receiving a handwriting input, wherein said interactive platform senses the handwriting input, so that the handwriting input is processed and outputted by said image-sensing and processing unit.

19. The interactive document camera to claim 18 wherein said interactive platform is electrically connected to said image-sensing and processing unit and comprises a multifunction menu having a plurality of virtual function keys, wherein touching one of said virtual function keys of said multifunction menu actuates function corresponding to said one virtual function key.
